(19) United States
(12) Patent Application Publication
(10) Pub. No.: US 2020/0160427 A1
(43) Pub. Date: May 21, 2020

(54) SYSTEMS AND METHODS FOR AGGREGATING, EXCHANGING, AND FILTERING DATA OVER A COMMUNICATIONS NETWORK

(71) Applicant: MASTERCARD INTERNATIONAL INCORPORATED, Purchase, NY (US)

(72) Inventors: David R. Crepps, O'Fallon, MO (US); Raghuraman Anantharaman, Wildwood, MO (US); Alper Inan, O'Fallon, MO (US); Brian Vienravee, St. Louis, MO (US); Christopher Dressler, St. Louis, MO (US)

(21) Appl. No.: 16/192,282

(22) Filed: Nov. 15, 2018

(51) Int. Cl. G06Q 30/06; G06F 17/30; G06Q 20/40

(52) U.S. Cl. CPC G06Q 30/0641; G06Q 20/401; G06Q 30/0627; G06F 17/30864

(57) ABSTRACT

A data aggregator (DA) system for aggregating data from multiple data sources over a communications network is provided. The DA system includes at least one data aggregator (DA) computing device configured to receive merchant data from a plurality of merchant computing devices, store the merchant data within the central database by mapping the merchant data using the merchant identifier, and receive a product request message from a user computing device. The DA computing device is also configured to perform a look up within the central database for a match product descriptor, receive a selection message from the user computing device, generate an authorization request message, and transmit the authorization request message to an authorizing party. The DA computing device is further configured to receive an authorization response message from the authorizing party, and transmit the authorization response message to the user computing device and a merchant.

### BACKGROUND

The field of the disclosure relates generally to secure network communications, and more specifically to methods and systems for aggregating, exchanging, and filtering data over a communications network.

Computing devices are oftentimes connected together so that one computing device is able to communicate with another computing device. In many cases, multiple computing devices are connected in such a manner that allows many different computing devices to communicate with many other computing devices. These communication links are typically referred to as networks. Thus, a network may consist of two or more computers that are communicatively linked together in order to share resources (e.g., printers, CDs, etc.), exchange files, or allow electronic communications. The computing devices may be connected at a plurality of remote locations through a network, such as the Internet.

The Internet provides consumers with unprecedented access to product information and purchasing opportunities. However, the product information and purchase opportunities are generally scattered in different Internet locations (e.g., websites and/or applications). Consumers may feel overwhelmed by the sheer quantity of available options or may lack the desire or time to undertake a detailed analysis of all available options in multiple Internet locations. Ultimately, an excess of choices scattered through the Internet may frustrate consumers, leading him or her to opt out of a purchase and causing a merchant to lose a sale. Accordingly, systems and methods that aggregate the product information and purchase opportunities in one network location are desired.

### BRIEF DESCRIPTION

In one aspect, a data aggregator (DA) system for aggregating data from multiple data sources over a communications network is provided. The DA system includes at least one data aggregator (DA) computing device that is communicatively coupled to a central database and is configured to receive merchant data from a plurality of merchant computing devices, wherein the merchant data includes a merchant identifier for each merchant associated with at least one of the plurality of merchant computing devices and product data for each product offered for sale by each merchant, wherein the product data includes a product identifier and a product descriptor, and wherein the product descriptor includes a description of each product offered for sale. The DA computing device is also configured to store the merchant data within the central database by mapping the merchant data using the merchant identifier, and receive a product request message from a user computing device, wherein the product request message includes at least one requested product identifier and at least one requested product descriptor associated with each requested product identifier, and wherein each requested product descriptor includes a requested product description.

The DA computing device is further configured to perform a look up within the central database for a match product descriptor including a match description matching the requested product description, wherein the match product descriptor is associated with a match product identifier, and receive a selection message from the user computing device, the selection message including a selected product identifier and a user identifier corresponding to a user of the user computing device, wherein the selected product identifier is associated with a selected merchant identifier corresponding to a merchant associated with one or more of the plurality of merchant computing devices. The DA computing device is also configured to generate an authorization request message including the user identifier and a price corresponding to the selected product identifier, transmit the authorization request message to an authorizing party, receive an authorization response message from the authorizing party, and transmit the authorization response message to the user computing device and the merchant.

In another aspect, a computer-implemented method for aggregating data from multiple data sources over a communications network is provided. The method is performed using at least one data aggregator (DA) computing device that includes at least one processor in communication with at least one memory device. The method includes receiving merchant data from a plurality of merchant computing devices, wherein the merchant data includes a merchant identifier for each merchant associated with at least one of the plurality of merchant computing devices and product data for each product offered for sale by each merchant, wherein the product data includes a product identifier and a product descriptor, and wherein the product descriptor includes a description of each product offered for sale. The method also includes storing the merchant data within the central database by mapping the merchant data using the merchant identifier, and receiving a product request message from a user computing device, wherein the product request message includes at least one requested product identifier and at least one requested product descriptor associated with each requested product identifier, and wherein each requested product descriptor includes a requested product description.

The method further includes performing a look up within the central database for a match product descriptor including a match description matching the requested product description, wherein the match product descriptor is associated with a match product identifier, and receiving a selection message from the user computing device, the selection message including a selected product identifier and a user identifier corresponding to a user of the user computing device, wherein the selected product identifier is associated with a selected merchant identifier corresponding to a merchant associated with one or more of the plurality of merchant computing devices. The method also includes generating an authorization request message including the user identifier and a price corresponding to the selected product identifier, transmitting the authorization request message to an authorizing party, receiving an authorization response message from the authorizing party, and transmitting the authorization response message to the user computing device and the merchant.

In yet another aspect, a non-transitory computer readable medium that includes executable instructions for aggregating data from multiple data sources over a communications network is provided. When the computer executable instructions are executed by a data aggregator (DA) computing device that includes at least one processor in communication with at least one memory device, the computer executable instructions cause the DA computing device to receive merchant data from a plurality of merchant computing devices, wherein the merchant data includes a merchant identifier for each merchant associated with at least one of the plurality of merchant computing devices and product data for each product offered for sale by each merchant, wherein the product data includes a product identifier and a product descriptor, and wherein the product descriptor includes a description of each product offered for sale. The computer executable instructions also cause the DA computing device to store the merchant data within the central database by mapping the merchant data using the merchant identifier, and receive a product request message from a user computing device, wherein the product request message includes at least one requested product identifier and at least one requested product descriptor associated with each requested product identifier, and wherein each requested product descriptor includes a requested product description.

The computer executable instructions further cause the DA computing device to perform a look up within the central database for a match product descriptor including a match description matching the requested product description, wherein the match product descriptor is associated with a match product identifier, and receive a selection message from the user computing device, the selection message including a selected product identifier and a user identifier corresponding to a user of the user computing device, wherein the selected product identifier is associated with a selected merchant identifier corresponding to a merchant associated with one or more of the plurality of merchant computing devices. The computer executable instructions also cause the DA computing device to generate an authorization request message including the user identifier and a price corresponding to the selected product identifier, transmit the authorization request message to an authorizing party, receive an authorization response message from the authorizing party, and transmit the authorization response message to the user computing device and the merchant.

### BRIEF DESCRIPTION OF THE DRAWINGS

FIGS. 1-7 show example embodiments of the methods and systems described herein.

FIG. 1 is a schematic diagram illustrating an example data aggregator (DA) system for aggregating and exchanging data over a communications network.

FIG. 2 is a schematic diagram illustrating an example multi-party payment processing system for enabling payment-by-card transactions.

FIG. 3 illustrates an example configuration of a user computing device shown in FIG. 1, in accordance with one embodiment of the present disclosure.

FIG. 4 illustrates an example configuration of server components for aggregating and exchanging data over the communications network shown in FIGS. 1 and 2.

FIG. 5 is a flow chart of an example process for aggregating and exchanging data over the communications network shown in FIGS. 1 and 2.

FIG. 6 is a schematic diagram illustrating an example process for aggregating and exchanging data over the communications network shown in FIGS. 1 and 2.

FIG. 7 is a diagram of components of one or more example computing devices that may be used in the DA system shown in FIG. 1.

### DETAILED DESCRIPTION

The following detailed description illustrates embodiments of the disclosure by way of example and not by way of limitation. The description clearly enables one skilled in the art to make and use the disclosure, and describes several embodiments, adaptations, variations, alternatives, and uses of the disclosure, including what is presently believed to be the best mode of carrying out the disclosure. The disclosure described herein is applied to an example embodiment, namely, methods and systems for utilizing a data aggregator (DA) system for aggregating, exchanging, and filtering data over a communications network. More specifically, the DA system provides a shopping client application (SCA) service that enables users enrolled in the service (e.g., users, registered users, and/or consumers) to securely purchase multiple items from different merchants using a single integrated website or web-application, and merchants enrolled in the service (e.g., merchants and/or registered merchants) to offer items online and securely sell such items to registered users. In other words, the DA system enables registered users and registered merchants to perform secure online payment transactions (e.g., card-not-present (CNP) payment transactions) while using a single website or web-application. The DA system described herein includes at least one data aggregator (DA) computing device.

The DA computing device includes at least one processor and at least one memory device communicatively coupled to the processor. The memory device stores computer instructions that, when executed by the processor, causes the processor to function as described herein. The DA system also includes a database and a database server communicatively coupled to the DA computing device. The database and the database server may also be referred to as central database. The term “central database” may be used interchangeably to refer to the database or the database server. The database and the database server may be separate from each other, and in at least some embodiments, the database and the database server are in communication with the DA computing device over different communication networks in a distributed architecture. The database and database server are configured to store data, such as merchant data, transaction data (e.g., payment data), user data, and other data that may be required for the DA system to function as described herein.

In the example embodiment, the merchant data may be transmitted by at least one merchant computing device associated with a merchant and may include, among other data, a merchant identifier, a merchant computing device identifier, product data for each product offered for sale by a merchant (e.g., product data relating to the goods or services offered by a merchant, such as at least one product identifier and at least one product descriptor including a description of each product associated with each product identifier), available number for each product (e.g., inventory quantity), merchant location identifier, metadata associated with each product (e.g., price, name of each product, product category, associated keywords with each product, among other metadata associated with each product), and metadata associated with each merchant location (e.g., hours of operation, applicable sales taxes, merchant-imposed fees, among other metadata associated with each merchant location).

In the example embodiment, the transaction data may include payment transactions initiated by a registered user using a user computing device accessing a web payment device (e.g., digital wallet, mobile payment, etc.) associated with a particular payment transaction processing network. The transaction data may also include, among other data points, a registered user and the merchant involved in the payment transaction. For example, transaction data may include one or more of: user account data (e.g., a primary account number (PAN)), user biometric data (e.g., or hashed version of biometric data), a user identifier, a merchant identifier, a merchant computing device identifier, a transaction amount, a time and date of the transaction, data descriptive of the purchase (e.g., product data relating to the goods or services purchased by the registered user, such as at least one selected product identifier), a location of the transaction, an authentication request message, an authorization request message, a user computing device identifier, and/or other data associated with the payment transaction.

In the example embodiment, the user data may include a user profile of a registered user. In other words, the user data may include, among other data, a user identifier, user authentication credentials (e.g., username, password, biometric data, security questions, security answers, or the like), user account data, a user computing device identifier, and/or other data associated with the user.

In some embodiments, the merchant data, transaction data, and/or user data are anonymized and aggregated (e.g., by the user computing device and/or the merchant computing device) prior to receipt by the DA computing device (i.e., no personally identifiable information (PII) is received by the DA computing device). In other embodiments, the DA computing device may be configured to receive the merchant data, transaction data, and/or user data without yet being anonymized and/or aggregated, and thus the DA computing device may be configured to anonymize and aggregate the merchant data, transaction data, and/or user data. In such embodiments, any PII received by the DA computing device is received and processed in an encrypted format, or is received with the consent of individuals with which the PII is associated. In situations in which the systems discussed herein collect personal information about individuals including users and/or merchants, or may make use of such personal information, individuals may be provided with an opportunity to control whether such information is collected or to control whether and/or how such information is used. In addition, certain data may be processed in one or more ways before it is stored or used, so that personally identifiable information is removed.

In the example embodiment, the DA computing device is in communication with multiple data sources that may include, but are not limited to, at least one merchant computing device (e.g., a smartphone, tablet, a point-of-sale (POS) terminal, or any other computing device able to communicate with the DA computing device), a payment processor that is part of a payment processing network, at least one user computing device (e.g., a web-based phone (e.g., a “smartphone”), a personal digital assistant (PDA), a desktop computer, a laptop computer, a cellular phone, a tablet, a phablet, or other web-based connectable equipment the user may use to communicate with the DA computing device), and at least one application program interface (API).

In the example embodiment, the DA computing device is configured to receive merchant data from at least one merchant computing device at the time of merchant enrollment in the SCA service. Once the DA computing device onboards a merchant in the SCA service, the DA computing device is configured to receive further merchant data. In some embodiments, the DA computing device may request, at a predefined period of time (e.g., minutes, days, and/or months), updated merchant data to a merchant computing device. In other embodiments, the DA computing device may receive merchant data without requesting such data. For example, a merchant may access the DA computing device to update associated merchant data. For example, the DA computing device may decrease or increase, based on the received merchant data, the inventory quantity for each product offered by each merchant. The DA computing device is also configured to store the merchant data in a centralized location (e.g., central database) in order to gain access to the merchant data associated with multiple merchants in real-time. As defined herein, real-time relates to the DA system processing data within a short period of time (e.g., from about milliseconds to minutes, or hours, as opposed to a matter of days) so that the data output and/or input is available virtually immediately.

After a merchant is enrolled (e.g., registered merchant) in the SCA service, users enrolled in the SCA service (e.g., registered users) may access the merchant data associated with the registered merchant. A user may enroll in the SCA service by using a user computing device and transmitting user data to the DA computing device. Once the DA computing device enrolls a user, the DA computing device is configured to transmit merchant data to the user computing device and instruct the user computing device to display such data. In the example embodiment, the DA computing device is accessed by the registered user via the user computing device and, more specifically, an electronic application program, such as, but not limited to, mobile application programs, web browsers and/or any suitable electronic application program that enables the DA system to function as described herein.

The user computing device may submit to the DA computing device a product request message (e.g., a search) for goods and/or services the user desires to search and/or purchase, so the DA computing device may perform a look up for the goods and/or services within a central database communicatively coupled to the DA computing device. The product request message may include data, such as a requested product identifier, one or more requested product identifiers, a quantity associated with each requested product identifier, a location of the user computing device, one or more merchant identifiers, and/or other data that enables the DA computing device to function as described herein.

The user computing device may submit the product request message in the form of keywords, bar code, Quick Response (QR) code, and other types of entry methods that enable the DA computing device to perform a look up for the goods and/or services within the central database. For example, the DA computing device may receive a product request message including a product identifier (e.g., a requested product identifier) and a product descriptor (e.g., a requested product descriptor) in the form of keyword for a good, such as “peanut butter.” The DA computing device parses the product request message and accesses the central database to perform a look up using the keywords “peanut” and “butter.”

When performing the look up, the DA computing device may use filters. In some embodiments, the filters are included in the product request message received from the user computing device. In other embodiments, the DA computing device retrieves the filters from the central database. The filters may include, but are not limited to, merchant data, such as a merchant identifier, a merchant location identifier, metadata associated with each requested product identifier (e.g., price, name of each product, product category, associated keywords with each product, among other metadata associated with each product), and metadata associated with each merchant location (e.g., hours of operation, applicable sales taxes, merchant-imposed fees, among other metadata associated with each merchant location). Other filters may be calculated filters. In some embodiments, the DA computing device is configured to generate the calculated filters. In other embodiments, the DA computing device is configured to receive the calculated filters which may be included within the product request message. The calculated filters may include, but are not limited to, product price range, a distance range between the merchant location and the location of the user computing device, a distance range between the merchant location and a location specified by the user computing device, and/or any other suitable filters that the DA computing device may utilize to perform the look up. The distance between locations may be calculated using a global positioning system (GPS) and/or other any suitable geolocation technology that enables the DA system to function as described herein.

In the example embodiment, the DA computing device is configured to perform the look up using the product request message and the filters. The DA computing device is also configured to parse the product request message, retrieve the data included in the product request message and match the retrieved data to data stored in within the central database. In some embodiments, the DA computing device is configured to retrieve the filters from the product request message and match the filters to the data stored within the central database. In other embodiments, the DA computing device is configured to retrieve the filters from the central database and link the filters to the data retrieved from the product request message. The DA computing device may be configured to retrieve the filters based on predefined configurations. For example, the DA computing device may be configured to retrieve filters based on a merchant location not greater than a distance of 2 miles radius from the location of the user computing device.

In some embodiments, the DA computing device is configured to match every piece of data included within the product request message to the data stored within the central database. In other embodiments, the DA computing device is configured to match partial data included within the product request message. In one example, the DA computing device may match only the requested product identifier to a product identifier (e.g., match product identifier) stored within the central database. In another example, the DA computing device may not match the requested product identifier included within the product request message to a product identifier stored within the central database, but may identify one or more product identifiers associated with similar products to the requested product identifier included within the product request message.

In the example embodiment, once the DA computing device has matched data included in the product request message to the stored data or has identified similar stored data to the data included in within the product request message, the DA computing device may transmit the matched and/or the identified similar data to the user computing device.

In certain embodiments, the DA computing device may be configured to instruct the user computing device to display the matched data in the form of a list in order of relevance based on the number of matched data between the data within the product request message and the data stored within the central database. In other embodiments, the DA computing device may be configured to instruct the user computing device to display the data in any suitable form that enables the DA system to function as described herein. If the DA computing device does not match the data within the product request message to the data within the central database, the DA computing device is configured to transmit a non-match notification to the user computing device. In the example embodiment, the DA computing device may perform a look up within the central database for similar data to the data included within the product request message, identify the similar data, and transmit to the user computing device the similar data (e.g., products and/or merchant suggestions) along with the non-match notification. The DA computing device may be configured to identify the similar data (e.g., generate suggestions) based on predefined criteria (e.g., values), such as product identifier, merchant identifier, merchant location identifier, and/or other criteria that enables the DA computing device to generate suggestions.

In one example, the DA computing device may receive, from a user computing device, a product request message including a requested product identifier corresponding to a product name (e.g., product description): 20 ounces brand X cereal box. The DA computing device is configured to parse the central database using the requested product identifier, find one or more merchant identifiers associated with the requested product identifier, retrieve the one or more merchant identifiers from the central database, generate a list including the one or more merchant identifiers and the requested product identifier, transmit the list to the user computing device, and instruct the user computing device to display the list including the one or more merchant identifiers and the requested product identifier. In another example, the DA computing device may receive, from a user computing device, a product request message including a requested product identifier corresponding to a product name: 20 ounces brand X cereal box. However, this time, when parsing the central database, the DA computing device does not find a merchant identifier associated with the requested product identifier. In this case, the DA computing device is configured to parse the central database to identify product names similar to the original product name (e.g., 20 ounces brand X cereal box). The DA computing device may be configured to perform a look up, for example, for brand X cereal box but different cereal box sizes from the original product box size (e.g., 15 ounces, 25 ounces, or the like).

The DA computing device may also be configured to perform a look up, for example, for different brand names from the original brand name but same cereal category and same cereal box size. The DA computing device is further configured to identify one or more merchant identifiers associated with similar product names, retrieve the one or more merchant identifiers and one or more product identifiers associated with the similar product names from the central database, generate a list including the one or more merchant identifiers and the one or more product identifiers associated with the similar product names, transmit the list to the user computing device, and instruct the user computing device to display the list to the user.

Once the list including the merchant identifiers and product names are displayed in the user computing device, a user may select one or more merchants and/or one or more product names using the user computing device. After the user inputs the selection in the user computing device, the user computing device transmits the selection, in the form of merchant selection data, along with transaction data to the DA computing device for electronic payment processing.

In the example embodiment, once the DA computing device receives the merchant selection data and the transaction data, the DA computing device is configured to retrieve, from the merchant selection data, a product identifier, a quantity associated with the product identifier, and a merchant identifier associated with the product identifier. The DA computing device is also configured to access the central database and use the retrieved data to decrease the product stock quantity (e.g., product inventory quantity) for the product associated with the retrieved product identifier and merchant identifier. In the example embodiment, the DA computing device is configured to transmit the merchant selection data to one or more merchant computing devices, each merchant computing device associated with a unique merchant identifier, and the transaction data to a payment processor, associated with an authorizing party (e.g., an issuer bank), for electronic processing. For example, the DA computing device may receive merchant selection data including one or more product identifiers associated with different merchant identifiers (e.g., when a user requests to purchase products from different merchants). In certain embodiments, the DA computing device is configured to transmit the merchant selection data and transaction data to the one or more merchant computing devices, and the one or more merchant computing devices may be configured to transmit the transaction data to the payment processor for electronic processing.

In the example embodiment, the transaction data includes, among other points described above, an authorization request message (e.g., ISO® 8583 compliant messages and ISO® 20022 compliant messages). The DA computing device is configured to transmit the transaction data to the payment processor, receive an authorization response message in response to the authorization request message from the payment processor, and transmit the merchant selection data along with the authorization response message to the one or more merchant computing devices.

In some embodiments, the DA computing device transmits the merchant selection data to the one or more merchant computing devices and the transaction data to the payment processor simultaneously or substantially simultaneously. In other embodiments, the DA computing device transmits the merchant selection data to the one or more merchant computing devices once the DA computing device has received an authorization response message from the payment processor.

Once the one or more merchant computing devices receive the merchant selection data, the DA computing device instructs the one or more merchant computing devices to display the merchant selection data. For example, the DA computing device may instruct the one or more merchant computing devices to display the product names associated with the product identifiers and quantities included in the merchant selection data. In some embodiments, the DA computing device does not instruct the merchant computing device to display the merchant selection data until the DA computing device receives the authorization response message and/or transmits the authorization response message to the merchant computing device.

After the merchant computing device displays the merchant selection data, a merchant may input a confirmation into the merchant computing device indicating that product identifiers included in the merchant selection data are available to the user. In other words, the products are available for shipping, pick-up, or use (in the case of services). The merchant computing device transmits the confirmation to the DA computing device. In some embodiments, the DA computing device is configured to decrease the product stock quantity once the DA computing device receives the confirmation from the merchant computing device. In the example embodiment, the DA computing device is configured to transmit the confirmation to the user computing device and instruct the user computing device to display the confirmation.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the term “database” may refer to either a body of data, a relational database management system (RDBMS), or to both. A database may include any collection of data including hierarchical databases, relational databases, flat file databases, object-relational databases, object oriented databases, and any other structured collection of records or data that is stored in a computer system. The above examples are for example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.).

The term processor, as used herein, may refer to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are for example only, and are thus not limiting as to the types of memory usable for storage of a computer program.

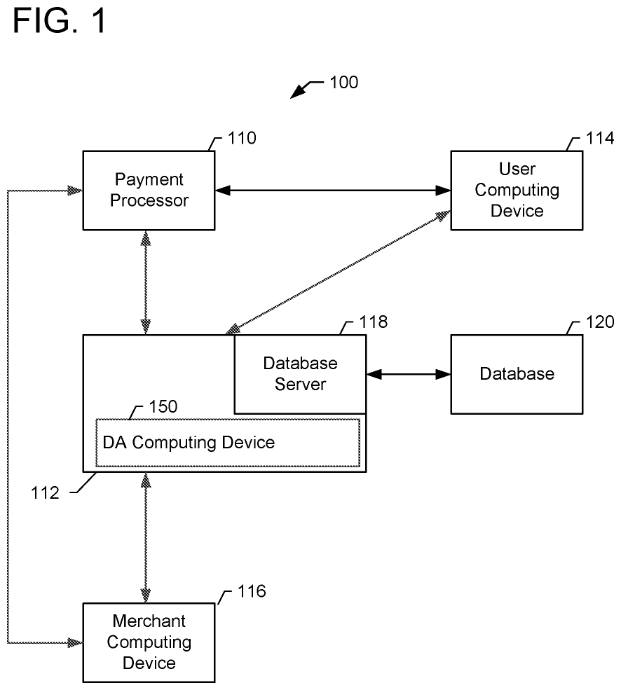

FIG. 1 is a simplified block diagram of an example data aggregator (DA) system 100 used for aggregating and exchanging data over a communications network in accordance with one example embodiment of the present disclosure. DA system 100 include a payment processor 110, which is part of a payment processing network which processes may be implemented in the performance of payment-by-card transactions. In an example embodiment, DA system 100 includes a payment processing network that includes a data aggregator (DA) computing device 150 configured to aggregate and exchange data over a communications network that is separate from, but in communication with the payment processing network.

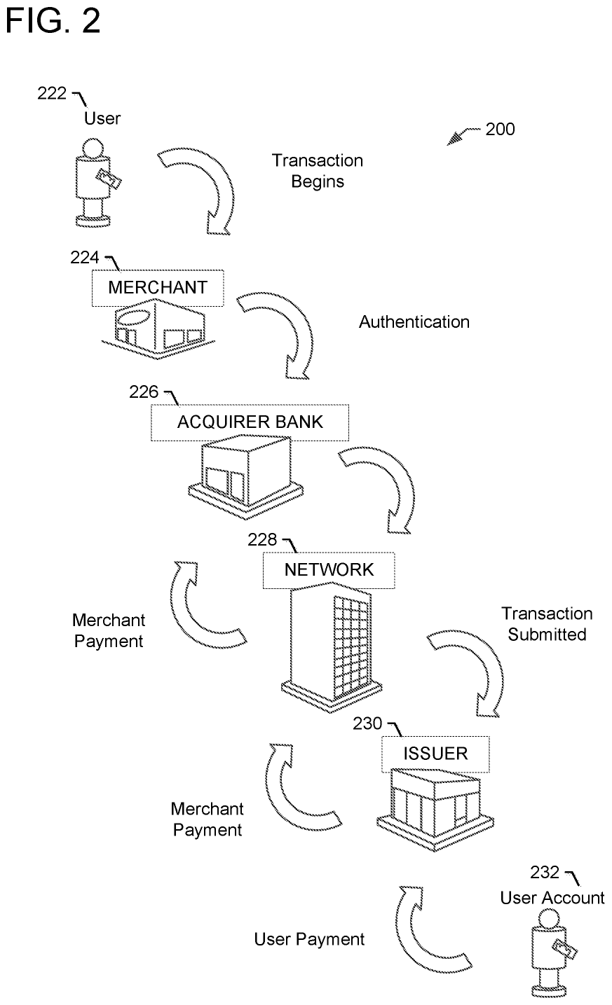

In the example embodiment, DA system 100 includes a server system 112, user computing device 114, and at least one merchant computing device 116. In some embodiments, user computing device 114 includes computing devices configured to implement a web browser or a software application, which enables user computing device 114 to access server system 112 using the Internet. User computing device 114 may be communicatively coupled to the Internet through many interfaces including, but is not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Alternatively, user computing device 114 includes any device capable of accessing the Internet including, but is not limited to, a desktop computer, a laptop computer, a personal digital assistant (PDA), a cellular phone, a smartphone, a tablet, a phablet, or other web-based connectable equipment. In some embodiments, user computing device 114 and merchant computing device 116 are similar. In other embodiments, user computing device 114 and merchant computing device 116 are different. In other words, merchant computing device 116 may be a POS system that may include, without limitation, machines that accept card swipes, online payment portals, digital wallet payments, or stored payment card numbers for recurring transaction. In the example embodiment, merchant computing device 116 is associated with at least one merchant 224 (shown in FIG. 2) and may be communicatively coupled to server system 112, payment processor 110, and/or merchant/acquirer bank 226 (shown in FIG. 2). User computing device 114 may be computing devices associated with at least one user 222 (show in FIG. 2), and may be communicatively coupled to server system 112, payment processor 110, and/or issuer bank 230 (shown in FIG. 2).

In one embodiment, server system 112 includes a database server 118 that is communicatively coupled to a database 120 for storing data. In the example embodiment, database 120 stores transaction data associated with one or more users 222 and/or merchants 224, user data associated with at least one user 222, merchant data associated with at least one merchant 224, and other data that may be required for DA computing device 150 to function as described herein. In other embodiments, server system 112 may store the data that is stored in database 120 in the database server 118.

According to the example embodiment, database 120 is disposed remotely from server system 112. In other embodiments, database 120 is centralized, and may be a part of server system 112. In the example embodiment, an administrator and/or an analyst (not shown) of DA system 100, user 222, and/or merchant 224 are able to access database 120 through a user computing device, such as user computing device 114, by logging onto server system 112. In the example embodiment, server system 112 may be associated with payment processor 110. Payment processor 110 may be associated with interchange network 228 (shown in FIG. 2).

In the example embodiment, server system 112 is associated with a financial transaction interchange network, such as interchange network 228 (also referred to as an interchange computer system). In some embodiments, server system 112 is used for processing transaction data and analyzing such data to identify product identifiers and merchant identifiers associated with the product identifiers. In one embodiment, at least one of user computing device 114 includes a computer system associated with an issuer of a transaction payment card and/or transaction payment account. Accordingly, server system 112 and user computing device 114 may be utilized to process transaction data relating to purchases user 222 makes utilizing a transaction card/account processed by interchange network 228 and issued by the associated issuer bank 230. In the exemplary embodiment, at least one user computing device 114 may be associated with user 222 seeking to register, access information, or process a transaction with at least one of interchange network 228, issuer bank 230, and/or merchant 224. In addition, user computing device 114 may be associated with merchant 224 and used for processing payment transactions.

In the example embodiment, DA system 100 provides a shopping client application (SCA) service that enables users, such as users 222, to enroll in the service to securely purchase multiple items from different merchants 224 using a single integrated website or web-application, and merchants enrolled in the service, such as merchants 224, to offer items online and securely sell such items to registered users.

In the example embodiment, DA computing device 150 is configured to receive merchant data from at least one merchant computing device 116 at the time of merchant 224 enrolls in the SCA service. Once merchant 224 is enrolled in the SCA service, DA computing device 150 is configured to receive further merchant data. In some embodiments, DA computing device 150 may request, at a predefined period of time (e.g., minutes, days, and/or months), updated merchant data to merchant computing device 116. In other embodiments, DA computing device 150 may receive merchant data without requesting such data. DA computing device 150 is also configured to store the merchant data in a centralized location in order to gain access to the merchant data associated with multiple merchants 224 in real-time.

After a merchant is enrolled, such as merchant 224, in the SCA service, users enrolled in the SCA service, such as users 222, may access the merchant data associated with merchant 224. A user may enroll the SCA service by using user computing device 114 and transmitting user data to DA computing device 150. Once DA computing device 150 enrolls user 222, DA computing device 150 is configured to transmit merchant data to user computing device 114 and instruct user computing device 114 to display such data. In the example embodiment, DA computing device 150 is accessed by user 222 via user computing device 114 and, more specifically, an electronic application that may be accessed by user computing device 114.

User computing device 114 may submit to DA computing device 150 a product request message for goods and/or services that user 222 desires to search and/or purchase, so DA computing device 150 may perform a look up for the goods and/or services within a database, such as database 120. User computing device 114 may submit the product request message in the form of keywords, bar code, Quick Response (QR) code, and other types of entry methods that enable DA computing device 150 to perform a look up for the goods and/or services within database 120. For example, DA computing device 150 may receive a product request message including a requested product identifier in the form of a keyword for a good, such as “peanut butter.” DA computing device 150 parses the product request message and accesses database 120 to perform a look up using the keywords “peanut” and “butter.”

When performing the look up, DA computing device 150 may use filters. In some embodiments, the filters are included in the product request message received from user computing device 114. In other embodiments, DA computing device 150 retrieves the filters from database 120. The filters may include, but are not limited to, merchant data, such as a merchant identifier, a merchant location identifier, metadata associated with each requested product identifier (e.g., price, name of each product, product category, associated keywords with each product, among other metadata associated with each product), and metadata associated with each merchant location (e.g., hours of operation, applicable sales taxes, merchant-imposed fees, among other metadata associated with each merchant location). Other filters may be calculated filters. In some embodiments, DA computing device 150 is configured to generate the calculated filters. In other embodiments, DA computing device 150 is configured to receive the calculated filters which may be included within the product request message. The calculated filters may include, but are not limited to, product price range, a distance range between the merchant location and the location of user computing device 114, a distance range between the merchant location and a location specified by user computing device 114, and/or any suitable filters that DA computing device 150 may utilize to perform the look up. The distance between locations may be calculated using a global positioning system (GPS) and/or other any other suitable geolocation technology that enables DA system 100 to function as described herein.

In the example embodiment, DA computing device 150 is configured to perform the look up using the product request message and the filters. DA computing device 150 is also configured to parse the product request message, retrieve the data included in the product request message and match the retrieved data to data stored within database 120. In some embodiments, DA computing device 150 is configured to retrieve the filters from the product request message and match the filters to the data stored within database 120. In other embodiments, DA computing device 150 is configured to retrieve the filters from database 120 and link the filters to the data retrieved from the product request message. DA computing device 150 may be configured to retrieve the filters based on predefined configurations. For example, DA computing device 150 may be configured to retrieve filters based on a merchant location not greater than a distance of 2 miles radius from the location of user computing device 114.

In some embodiments, DA computing device 150 is configured to match every piece of data included within the product request message to the data stored within database 120. In other embodiments, DA computing device 150 is configured to match partial data included within the product request message. In one example, DA computing device 150 may match only the requested product identifier to the stored data. In another example, DA computing device 150 may not match the requested product identifier included within the product request message to a product identifier (e.g., match identifier) stored within database 120, but may identify one or more product identifiers associated with similar products to the requested product identifier included within the product request message.

In the example embodiment, once DA computing device 150 has matched data included in the product request message to the stored data or has identified similar stored data to the data included in within the product request message, DA computing device 150 may transmit the matched and/or the identified similar data to user computing device 114.

In certain embodiments, DA computing device 150 may be configured to instruct user computing device 114 to display the matched data in the form of a list in order of relevance based on the number of matched data between the data within the product request message and the data stored within database 120. In other embodiments, DA computing device 150 may be configured to instruct user computing device 114 to display the data in any suitable form that enables DA system 100 to function as described herein. If DA computing device 150 does not match the data within the product request message to the data within database 120, DA computing device 150 is configured to transmit a non-match notification to user computing device 114. In the example embodiment, DA computing device 150 may perform a look up within database 120 for similar data to the data included within the product request message, identify the similar data, and transmit to user computing device 114 the similar data (e.g., products and/or merchant suggestions) along with the non-match notification. DA computing device 150 may be configured to identify the similar data (e.g., generate suggestions) based on predefined criteria (e.g., values), such as product identifier, merchant identifier, merchant location identifier, and/or other criteria that enables DA computing device 150 to generate suggestions.

In one example, DA computing device 150 may receive, from user computing device 114, a product request message including a requested product identifier corresponding to a product name (e.g., product description): 20 ounces brand X cereal box. DA computing device 150 is configured to parse the central database using the requested product identifier, find one or more merchant identifiers each associated with a match product identifier matching the requested product identifier, retrieve the one or more merchant identifiers and the match product identifier from the database, generate a list including the one or more merchant identifiers and the match product identifier, transmit the list to the user computing device, and instruct the user computing device to display the list including the one or more merchant identifiers and the match product identifier. In another example, DA computing device 150 may receive, from user computing device 114, a product request message including a requested product identifier corresponding to a product name: 20 ounces brand X cereal box. However, this time, when parsing database 120, DA computing device 150 does not find a merchant identifier associated with the requested product identifier. In this case, DA computing device 150 is configured to parse database 120 to identify product names similar to the original product name (e.g., 20 ounces brand X cereal box). In one example, DA computing device 150 may be configured to perform a look up for brand X cereal box but different cereal box sizes from the original product box size (e.g., 15 ounces, 25 ounces, or the like).

In another example, DA computing device 150 may also be configured to perform a look up, for example, for different brand names from the original brand name but same cereal category and same cereal box size. DA computing device 150 is further configured to identify one or more merchant identifiers associated with similar product names, retrieve the one or more merchant identifiers and the similar product from database 120, generate a list including the one or more merchant identifiers and the similar product names, transmit the list to user computing device 114, and instruct user computing device 114 to display a list including the one or more merchant identifiers and the similar product names.

Once the list including the merchant identifiers and the similar product names is displayed in user computing device 114, user 222 may select one or more merchants and/or one or more product names using user computing device 114. After user 222 inputs the selection in user computing device 114, user computing device 114 transmits the selection, in the form of merchant selection data, along with transaction data to DA computing device 150 for electronic payment processing.

In the example embodiment, once DA computing device 150 receives the merchant selection data and the transaction data, DA computing device 150 is configured to retrieve, from the merchant selection data, a product identifier, a quantity associated with the product identifier, and a merchant identifier associated with the product identifier. DA computing device 150 is also configured to access database 120 and use the retrieved data to decrease the product stock quantity for the product associated with the retrieved product identifier and merchant identifier. In the example embodiment, DA computing device 150 is configured to transmit the merchant selection data to one or more merchant computing devices 116, each merchant computing device 116 associated with a unique merchant identifier, and the transaction data to payment processor 110 for electronic processing. For example, DA computing device 150 may receive merchant selection data including one or more product identifiers associated with different merchant identifiers (e.g., when a user requests to purchase products from different merchants). In certain embodiments, DA computing device 150 is configured to transmit the merchant selection data and transaction data to one or more merchant computing devices 116. One or more merchant computing devices 116 may be configured to transmit the transaction data to payment processor 110 for electronic processing.

In the example embodiment, the transaction data includes, among other points described above, an authorization request message (e.g., ISO® 8583 compliant messages and ISO® 20022 compliant messages). DA computing device 150 is configured to transmit the transaction data to payment processor 110, receive an authorization response message in response to the authorization request message from payment processor 110, and transmit the merchant selection data along with the authorization response message to one or more merchant computing devices 116.

In some embodiments, DA computing device 150 transmits the merchant selection data to one or more merchant computing devices 116 and the transaction data to payment processor 110 simultaneously or substantially simultaneously. In other embodiments, DA computing device 150 transmits the merchant selection data to one or more merchant computing devices 116 once DA computing device 150 has received an authorization response message from payment processor 110.

Once one or more merchant computing devices 116 receive the merchant selection data, DA computing device 150 instructs one or more merchant computing devices 116 to display the merchant selection data. For example, DA computing device 150 may instruct one or more merchant computing devices 116 to display the product names associated with the product identifiers and quantities included in the merchant selection data. In some embodiments, DA computing device 150 does not instruct one or more merchant computing devices 116 to display the merchant selection data until DA computing device 150 receives the authorization response message and/or transmits the authorization response message to one or more merchant computing devices 116.

After one or more merchant computing devices 116 display the merchant selection data, merchant 224 may input a confirmation into one or more merchant computing devices 116 indicating that product identifiers included in the merchant selection data are available to user 222. In other words, the products are available for shipping, pick-up, or use (in the case of services). One or more merchant computing devices 116 transmit the confirmation to DA computing device 150. In some embodiments, DA computing device 150 is configured to decrease the product stock quantity (e.g., product inventory quantity) once DA computing device 150 receives the confirmation from one or more merchant computing devices 116. In the example embodiment, DA computing device 150 is configured to transmit the confirmation to user computing device 114 and instruct user computing device 114 to display the confirmation to user 222.

FIG. 2 is a schematic diagram illustrating an example multi-party payment processing system 200 for aggregating, exchanging, and filtering data over a communications network. Embodiments described herein may relate to a transaction card system, such as a credit card payment system using the Mastercard® interchange network. The Mastercard® interchange network is a set of proprietary communications standards promulgated by Mastercard International Incorporated® for the exchange of financial transaction data and the settlement of funds between financial institutions that are members of Mastercard International Incorporated®. (Mastercard is a registered trademark of Mastercard International Incorporated located in Purchase, New York).

As described with respect to payment processing system 200, a financial institution called the “issuer” issues a transaction card or electronic payments account identifier, such as a credit card or debit card, to a user, cardholder, or user 222, who uses the transaction card to tender payment for a purchase from a merchant 224. To accept payment with the transaction card, merchant 224 must normally establish an account with a financial institution that is part of the financial payment system. This financial institution is usually called the “merchant bank,” the “acquirer bank,” or the “acquirer.” When user 222 tenders payment for a purchase with a transaction card, merchant 224 requests authorization from an acquirer bank 226 for the amount of the purchase. The request may be performed over the telephone, but is usually performed through the use of a point-of-sale (POS) terminal or a computing device, which reads user's 222 account information from a magnetic stripe, a chip, or embossed characters on the transaction card and communicates electronically with the transaction processing computers of acquirer bank 226. Alternatively, acquirer bank 226 may authorize a third party to perform transaction processing on its behalf. In this case, the POS terminal will be configured to communicate with the third party. Such a third party is usually called a “merchant processor,” an “acquiring processor,” or a “third party processor.”

Using an interchange network 228, computers of acquirer bank 226 or merchant processor will communicate with computers of an issuer bank 230 to determine whether user account 232 associated with user 222 is in good standing and whether the purchase is covered by user account 232 available credit line. Based on these determinations, the request for authorization will be declined or accepted. If the request is accepted, an authorization code is issued to merchant 224.

When a request for authorization is accepted, the available credit line of user account 232 is decreased. Normally, a charge for a payment card transaction is not posted immediately to user account 232 because bankcard associations, such as Mastercard International Incorporated®, have promulgated rules that do not allow merchant 224 to charge, or “capture,” a transaction until goods are shipped or services are delivered. However, with respect to at least some debit card transactions, a charge may be posted at the time of the transaction. When merchant 224 ships or delivers the goods or services, merchant 224 captures the transaction by, for example, appropriate data entry procedures on the POS terminal. This may include bundling of approved transactions daily for standard retail purchases. If user 222 cancels a transaction before it is captured, a “void” is generated. If user 222 returns goods after the transaction has been captured, a “credit” is generated. Interchange network 228 and/or issuer bank 230 stores the transaction card information, such as a category of merchant, a merchant identifier, a location where the transaction was completed, amount of purchase, and date and time of the transaction in a database 120 (shown in FIG. 1).

After a purchase has been made, a clearing process occurs to transfer additional transaction data related to the purchase among the parties to the transaction, such as acquirer bank 226, interchange network 228, and issuer bank 230. More specifically, during and/or after the clearing process, additional data, such as a time of purchase, a merchant name, a type of merchant, purchase information, cardholder account information, a type of transaction, itinerary information, information regarding the purchased item and/or service, and/or other suitable information associated with a transaction and transmitted between parties to the transaction as transaction data, and may be stored by any of the parties to the transaction.

For debit card transactions, when a request for a personal identification number (PIN) authorization is approved by the issuer bank 230, user account 232 is decreased. Normally, a charge is posted immediately to user account 232. The payment card association then transmits the approval to the acquiring processor for distribution of goods/services or information, or cash in the case of an automated teller machine (ATM).

After a transaction is authorized and cleared, the transaction is settled among merchant 224, acquirer bank 226, and issuer bank 230. Settlement refers to the transfer of financial data or funds among acquirer bank 226, issuer bank 230, and merchant's 224 account related to the transaction. Usually, transactions are captured and accumulated into a “batch,” which is settled as a group. More specifically, a transaction is typically settled between issuer bank 230 and interchange network 228, and then between interchange network 228 and acquirer bank 226, and then between acquirer bank 226 and merchant 224.

In some embodiments, user 222 registers one or more payment cards with a digital wallet. Having done this, user 222 can interact with a participating online merchant 224. At the check-out stage, online merchant 224 displays a button on the merchant website which user 222 can click on in order to make a payment using user 222 digital wallet. Online merchant 224 then redirects user 222 to a “switch” operated by interchange network 228. Using a cookie located on user computing device 114 (shown in FIG. 1), the “switch” is able to determine which wallet-hosting server hosts a wallet associated with user 222. The switch then establishes a connection between user computing device 114 and the appropriate wallet-hosting system, which presents user 222 with a sign-in page (e.g., as a pop-up window), where there is an authentication process (e.g., entry of a pre-agreed password). This log-in process may use the same login credentials (e.g., password) which user 222 also uses to obtain access to other online banking activities.

In some embodiments, a unique identifier is provided to user 222. The unique identifier is different from the number associated with user account 232. In these embodiments, interchange network 228 stores the unique identifier in database 120 along with user account 232. When interchange network 228 receives the unique identifier, interchange network 228 determines the associated user account 232 and uses that information in processing the payment transaction.

The wallet-hosting system then securely transfers user 222 payment information to the online merchant's domain. The merchant's domain submits user's 222 payment information to acquirer bank 226 for a separate authorization process in which the acquiring domain communicates with the issuer bank 230 to ask the bank to authorize the transaction. Thus, user 222 is not required to enter their card details (except at the stage of initially registering with the wallet-hosting system), and the online transaction process is streamlined with only a single redirection, and consistent branding for the entire payment process, irrespective of the online merchant 224.

In the example embodiment, when user 222 completes selecting the goods and/or services that he or she desires to purchase, user 222 inputs one or more products into user computing device 114 via keywords, bar code, Quick Response (QR) code, and/or other types of entry methods, user computing device 114 may prompt to user 222 one or more authentication criteria (a personal identification number (PIN), or biometric authentication) in order to proceed. In other embodiments, the authentication criteria are requested prior to user 222 inputting the one or more products in to user computing device 114. After the authentication criteria is met, user computing device 114 may prompt to user 222 payment credentials that user 222 may select. User computing device 114 may also prompt to user 222 a list including products that are similar to the one or more products inputted by user 222 and one or more merchants (e.g., merchant 224) offering the similar products in the list. User 222 may select one or more products and one or more merchants from the list, and user 222 payment credentials. In the example embodiment, user computing device 114 displays the transaction amount for the purchase and user 222 confirms the transaction amount for the purchase. An application in user computing device 114 generates transaction data including the amount of the purchase and transmits the transaction data to acquirer bank 226 based upon the information selected by user 222.

Acquirer bank 226 receives the transaction data, performs checks on the transaction data, and transmits the data to interchange network 228. Interchange network 228 performs domain control validations and de-tokenization on the transaction data. Interchange network 228 also performs PIN/shred secret for the authorization message included in the transaction data. Interchange network 228 transmits the authorization message to issuer bank 230. Issuer bank 230, in response to the authorization message, generates an authorization response. Issuer bank 230 transmits the authorization response to interchange network 228. Interchange network 228 transmits the authorization response to acquirer bank 226, which transmits the authorization response in the form of an approved or decline notification to one or more merchant computing devices 116 (shown in FIG. 1) associated with merchant 224 and to user computing device 114 associated with user 222.

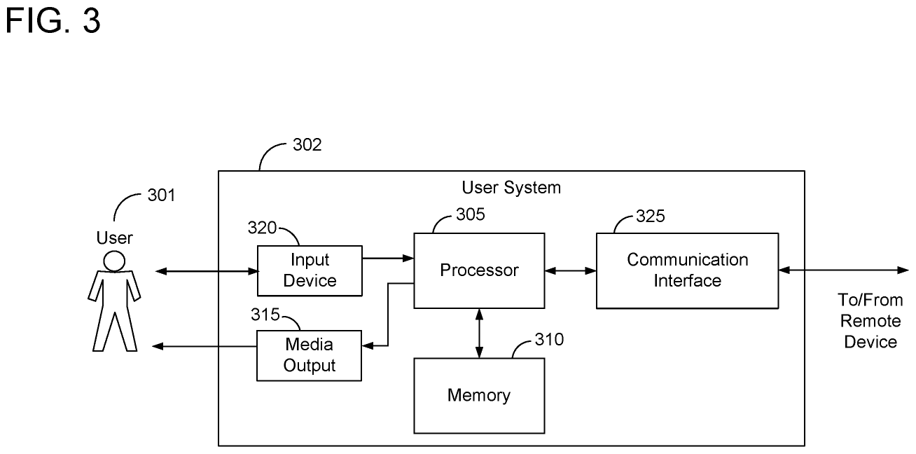

FIG. 3 illustrates an example configuration of a user system 302, such as user computing device 114 (shown in FIG. 1) configured to transmit data to DA computing device 150 (shown in FIG. 1). User system 302 may include, but is not limited to, user computing device 114. In the example embodiment, user system 302 includes a processor 305 for executing instructions. In some embodiments, executable instructions are stored in a memory 310. Processor 305 may include one or more processing units, for example, a multi-core configuration. Memory 310 is any device allowing information such as executable instructions and/or written works to be stored and retrieved. Memory 310 may include one or more computer readable media.

User system 302 also includes at least one media output component 315 for presenting information to user 301. User 301 may include, but is not limited to, user 222 (shown in FIG. 2). Media output component 315 is any component capable of conveying information to user 301. For example, media output component 315 may be a display component configured to display component lifecycle data in the form of reports, dashboards, communications, and the like. In some embodiments, media output component 315 includes an output adapter such as a video adapter and/or an audio adapter. An output adapter is operatively coupled to processor 305 and operatively connectable to an output device, such as a display device, a liquid crystal display (LCD), organic light emitting diode (OLED) display, or “electronic ink” display, or an audio output device, a speaker or headphones.

In some embodiments, user system 302 includes an input device 320 for receiving input from user 301. Input device 320 may include, for example, a keyboard, a pointing device, a mouse, a stylus, a touch sensitive panel, a touch pad, a touch screen, a gyroscope, an accelerometer, a position detector, an audio input device, a fingerprint reader/scanner, a palm print reader/scanner, a iris reader/scanner, a retina reader/scanner, a profile scanner, or the like. A single component, such as a touch screen, may function as both an output device of media output component 315 and input device 320. A single component, such as a touch screen, may function as both an output device of media output component 315 and input device 320. User system 302 may also include a communication interface 325, which is communicatively connectable to a remote device such as server system 112 (shown in FIG. 1). Communication interface 325 may include, for example, a wired or wireless network adapter or a wireless data transceiver for use with a mobile phone network, Global System for Mobile communications (GSM), 3G, or other mobile data network or Worldwide Interoperability for Microwave Access (WIMAX).

Stored in memory 310 are, for example, computer readable instructions for providing a user interface to user 301 via media output component 315 and, optionally, receiving and processing input from input device 320. A user interface may include, among other possibilities, a web browser, and client application. Web browsers enable users, such as user 301, to display and interact with media and other information typically embedded on a web page or a website from server system 112. A client application allows user 301 to interact with a server application from server system 112.

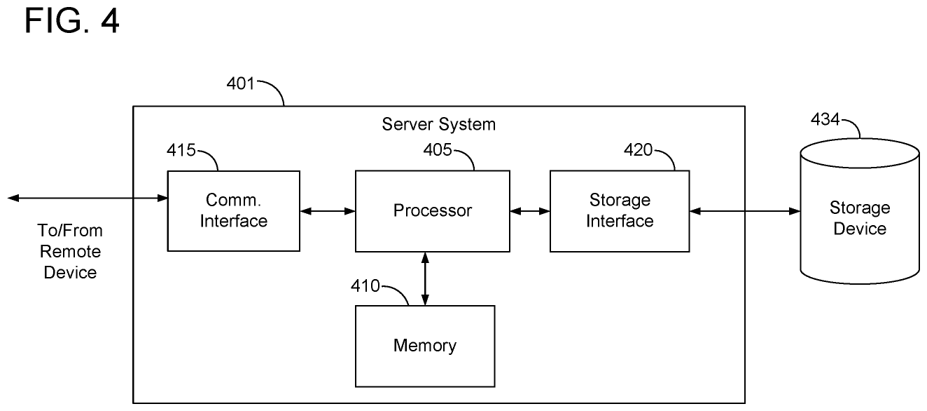

FIG. 4 illustrates an example configuration of a server system 401 such as server system 112 (shown in FIG. 1) that includes DA computing device 150 (shown in FIG. 1). Server system 401 may include, but is not limited to, database server 118 (shown in FIG. 1) and/or DA computing device 150. In some embodiments, server system 401 is similar to server system 112.

Server system 401 includes a processor 405 for executing instructions. Instructions may be stored in a memory 410, for example. Processor 405 may include one or more processing units (e.g., in a multi-core configuration) for executing instructions. The instructions may be executed within a variety of different operating systems on the server system 401, such as UNIX, LINUX, Microsoft Windows®, etc. More specifically, the instructions may cause various data manipulations on data stored in storage device 434 (e.g., create, read, update, and delete procedures). It should also be appreciated that upon initiation of a computer-based method, various instructions may be executed during initialization. Some operations may be required in order to perform one or more processes described herein, while other operations may be more general and/or specific to a particular programming language (e.g., C, C #, C++, Java, or other suitable programming languages, etc.).

Processor 405 is operatively coupled to a communication interface 415 such that server system 401 is capable of communicating with a remote device, such as a user system or another server system 401. For example, communication interface 415 may receive communications from user computing device 114 via a plurality of network connections, as illustrated in FIG. 1.

Processor 405 may also be operatively coupled to a storage device 434. Storage device 434 is any computer-operated hardware suitable for storing and/or retrieving data. In some embodiments, storage device 434 is integrated in server system 401. In other embodiments, storage device 434 is external to server system 401 and is similar to database 120 (shown in FIG. 1). For example, server system 401 may include one or more hard disk drives as storage device 434. In other embodiments, storage device 434 is external to server system 401 and may be accessed by a plurality of server systems 401. For example, storage device 434 may include multiple storage units such as hard disks or solid state disks in a redundant array of inexpensive disks (RAID) configuration. Storage device 434 may include a storage area network (SAN) and/or a network attached storage (NAS) system.

In some embodiments, processor 405 is operatively coupled to storage device 434 via a storage interface 420. Storage interface 420 is any component capable of providing processor 405 with access to storage device 434. Storage interface 420 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 405 with access to storage device 434.

Memory 410 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

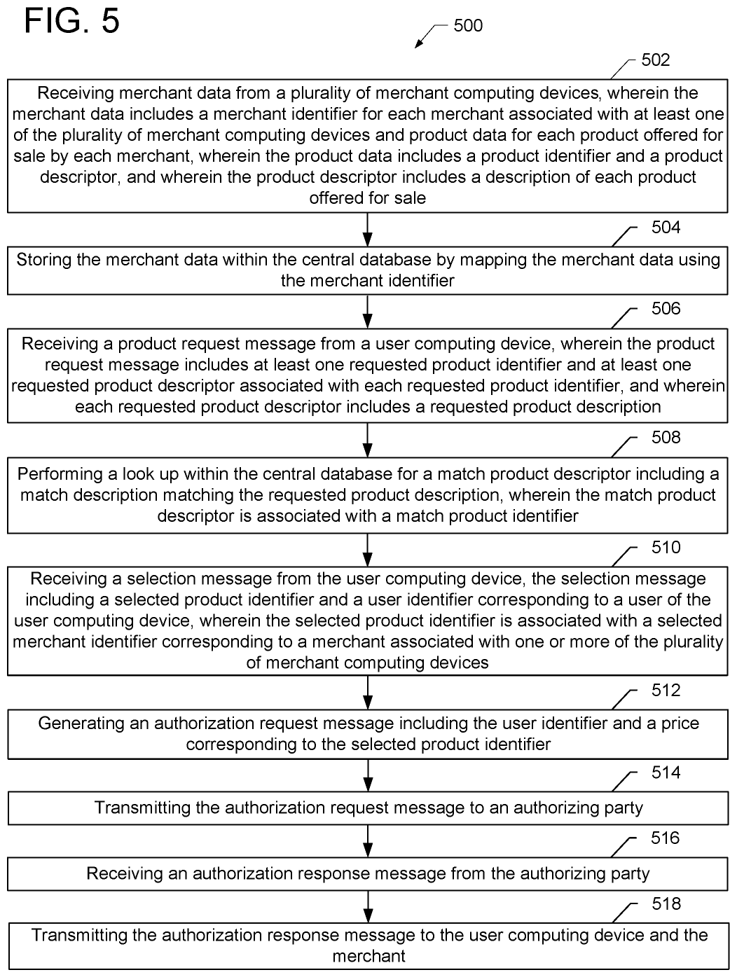

FIG. 5 is an example flow diagram illustrating a method flow 500 by which at least one DA computing device 150 (shown in FIG. 1) aggregates data from multiple data sources over a communications network. Method 500 includes receiving 502 merchant data from a plurality of merchant computing devices, wherein the merchant data includes a merchant identifier for each merchant associated with at least one of the plurality of merchant computing devices and product data for each product offered for sale by each merchant, wherein the product data includes a product identifier and a product descriptor, and wherein the product descriptor includes a description of each product offered for sale. Method 500 also includes storing 504 the merchant data within the central database by mapping the merchant data using the merchant identifier, and receiving 506 a product request message from a user computing device, wherein the product request message includes at least one requested product identifier and at least one requested product descriptor associated with each requested product identifier, and wherein each requested product descriptor includes a requested product description.

Method 500 further includes performing 508 a look up within the central database for a match product descriptor including a match description matching the requested product description, wherein the match product descriptor is associated with a match product identifier, and receiving 510 a selection message from the user computing device, the selection message including a selected product identifier and a user identifier corresponding to a user of the user computing device, wherein the selected product identifier is associated with a selected merchant identifier corresponding to a merchant associated with one or more of the plurality of merchant computing devices. Method 500 also includes generating 512 an authorization request message including the user identifier and a price corresponding to the selected product identifier, transmitting 514 the authorization request message to an authorizing party, receiving 516 an authorization response message from the authorizing party, and transmitting 518 the authorization response message to the user computing device and the merchant.

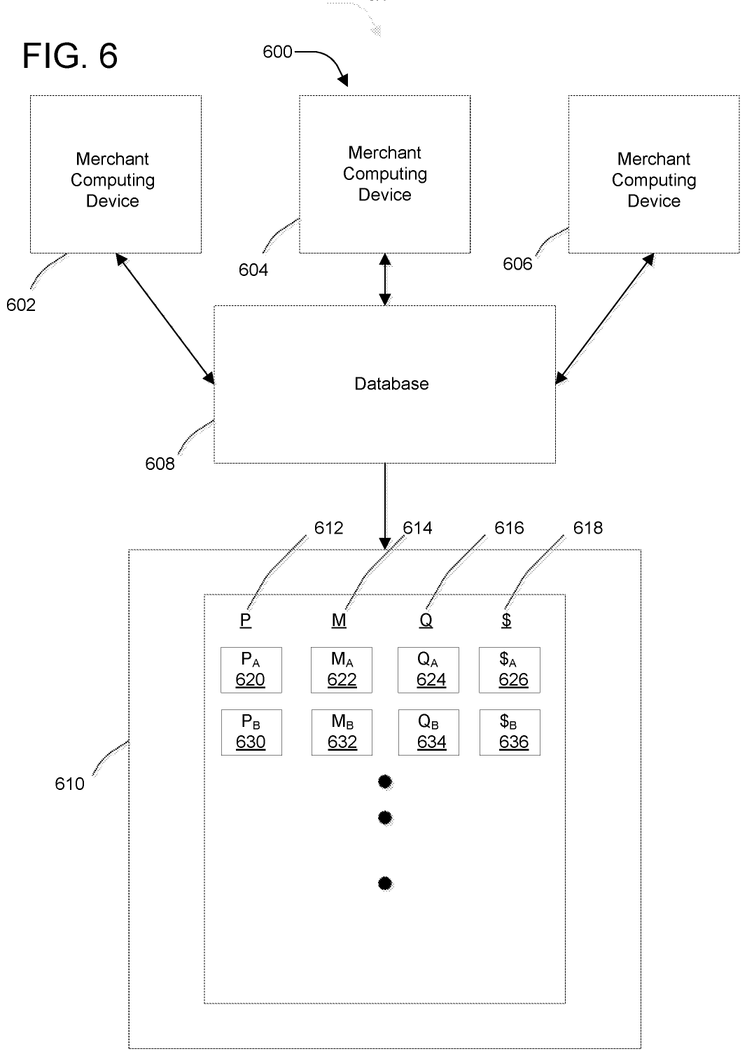

FIG. 6 is a schematic diagram illustrating an example process 600 for aggregating and exchanging data over a communications network. In the example process 600, DA computing device 150 (shown in FIG. 1) receives merchant data from merchant computing devices 602, 604, and 606. Merchant computing devices 602, 604, and 606 are similar to merchant computing device 116 (shown in FIG. 1). After receiving the merchant data, DA computing device 150 stores the merchant data within a database, such as database 608 (similar to database 120 shown in FIG. 1). The merchant data may include a merchant identifier, a merchant computing device identifier, product data, and other data, as described above.

DA computing device 150 is configured to use the merchant data to enroll merchants, such as merchants 224 (shown in FIG. 2), associated with merchant computing devices 602, 604, and 606 in to shopping client application (SCA) service, as described above. After the merchants are enrolled, users enrolled in the SCA service, such as users 222 (shown in FIG. 2), may access the merchant data associated with the merchants. A user may enroll the SCA service by using user computing device 610 (similar to user computing device 114 shown in FIG. 1) and transmitting user data to DA computing device 150. Once DA computing device 150 enrolls the user, DA computing device 150 is configured to transmit merchant data to user computing device 610 and instruct user computing device 610 to display such data. In the example embodiment, DA computing device 150 is accessed by the user via user computing device 610 and, more specifically, an electronic application that may be accessed by user computing device 610.

The user of user computing device 610 may submit to DA computing device 150, via user computing device 610, a product request message for goods and/or services that the user desires to search and/or purchase, so DA computing device 150 may perform a look up for the goods and/or services within database 608. User computing device 610 may submit the product request message in a vast variety of forms as described above with respect to user computing device 114. DA computing device 150 is also configured to parse the product request message and access database 608 to perform the look up using keywords included in the product request message. In the example embodiment, the keywords are associated with the good and/or services that the user desires to search and/or purchase.

When performing the look up, DA computing device 150 may use filters. In some embodiments, the filters are included in the product request message received from user computing device 610. In other embodiments, DA computing device 150 retrieves the filters from database 608. The filters may include, but are not limited to, merchant data. Other filters may be calculated filters. In some embodiments, DA computing device 150 is configured to generate the calculated filters. In other embodiments, DA computing device 150 is configured to receive the calculated filters which may be included within the product request message. The calculated filters may include, but are not limited to, product price range, a distance range between the merchant location and the location of user computing device 610, a distance range between the merchant location and a location specified by user computing device 610, and/or any suitable filters that DA computing device 150 may utilize to perform the look up.

In the example embodiment, DA computing device 150 is configured to perform the look up using the product request message and the filters. DA computing device 150 is also configured to parse the product request message, retrieve the data included in the product request message and match the retrieved data to data stored within database 608. In some embodiments, DA computing device 150 is configured to retrieve the filters from the product request message and match the filters to the data stored within database 608. In other embodiments, DA computing device 150 is configured to retrieve the filters from database 608 and link the filters to the data retrieved from the product request message. DA computing device 150 may be configured to retrieve the filters based on predefined configurations. For example, DA computing device 150 may be configured to retrieve filters based on a merchant location not greater than a distance of 2 miles radius from the location of user computing device 610.

In some embodiments, DA computing device 150 is configured to match every piece of data included within the product request message to the data stored within database 608. In other embodiments, DA computing device 150 is configured to match partial data included within the product request message, as described above. Once DA computing device 150 has matched data included in the product request message to the stored data or has identified similar stored data to the data included in within the product request message, DA computing device 150 is configured to transmit the matched and/or the identified similar data to user computing device 610.

In the example embodiment, DA computing device 150 is configured to instruct user computing device 610 to display the matched data in the form of a list. For example, products may be under P column 612, merchants may be under M column 614, product quantity may be under Q column 616, and product price may be under $ column 618. In the example embodiment, DA computing device 150 instructs user computing device 610 to display the list in order of relevance based on the number of matched data between the data within the product request message and the data stored within database 608. The list may be displayed by a user interface of user computing device 610. In one example, product P_{A} 620 and/or product P_{B} 630 may be the exact product (e.g., type, size, and brand) that user computing device 610 submitted to DA computing device 150 for search. In another example, product P_{A} 620 and/or product P_{B} 630 may be the most similar product (e.g., type and size) that user computing device 610 submitted to DA computing device 150 for search. In the example embodiment, DA computing device 150 instructs user computing device 610 to display merchant M_{A} 622 offering product P_{A} 620, quantity Q_{A} 624 of product P_{A} 620 at merchant M_{A} 622, and price $_{A} 626 of product P_{A} 620 at merchant M_{A} 622 on the same row. In yet another example, product P_{B} 630 may be the second most similar product after product P_{A} 620 based on the product for search submitted by user computing device 610. Just like the row of product P_{A} 620, DA computing device 150 instructs user computing device 610 to display merchant M_{B} 632 offering product P_{B} 630, quantity Q_{B} 634 of product P_{B} 630 at merchant M_{B} 632, and price $_{B} 636 of product P_{B} 630 at merchant M_{B} 632 on the same row. In other embodiments, product P_{B} 630 may be offered by merchant M_{A} 622 and product P_{A} 620 may be offered by merchant M_{B} 632. DA computing device 150 is configured to instruct user computing device 610 to display the list including all the merchants that meet the criteria of the goods and/or services search submitted by user computing 610. In other embodiments, DA computing device 150 may be configured to instruct user computing device 610 to display the data in any suitable form that enables DA system 100 (show in FIG. 1) to function as described herein.

If DA computing device 150 does not match the data within the product request message to the data within database 608, DA computing device 150 is configured to transmit a non-match notification to user computing device 610. In the example embodiment, DA computing device 150 may perform a look up within database 608 for similar data to the data included within the product request message, identify the similar data, transmit to user computing device 608 the similar data along with the non-match notification, and display similar data, as described above, along with the non-match notification. DA computing device 150 may be configured to identify the similar data based on predefined criteria, such as a product identifier, a product descriptor, merchant identifier, merchant location identifier, and/or other criteria that enables DA computing device 150 to generate suggestions.

Once the list is displayed in user computing device 610, the user of user computing device 610 may select one or more merchants and/or one or more product names using user computing device 610. After the user inputs the selection in user computing device 610, user computing device 610 transmits the selection, in the form of merchant selection data, along with transaction data, to DA computing device 150 for electronic payment processing, as described above.

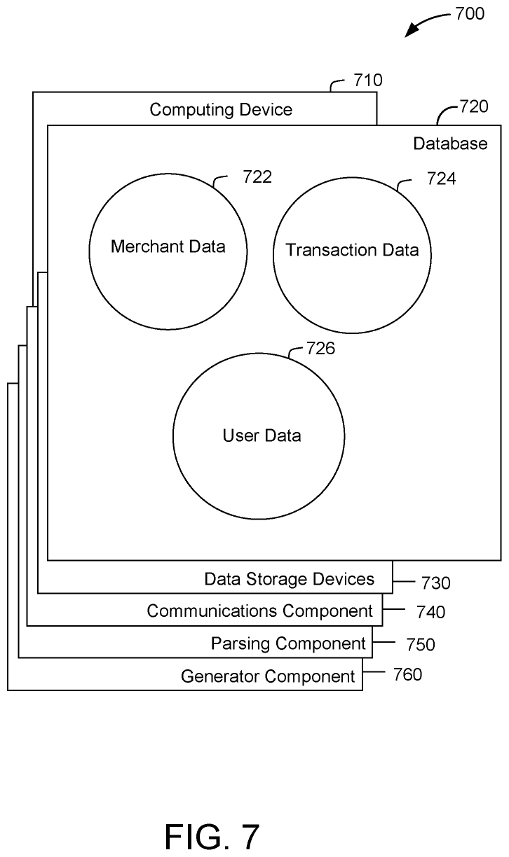

FIG. 7 is a diagram 700 of components of one or more example computing devices that may be used in DA system 100 shown in FIG. 1. In some embodiments, computing device 710 is similar to DA computing device 150 (shown in FIG. 1). Database 720 may be coupled with several separate components within computing device 710, which perform specific tasks. In this embodiment, database 720 includes merchant data 722, transaction data 724, and user weight 726. In some embodiments, database 720 is similar to database 120 (shown in FIG. 1).

Computing device 710 includes database 720, as well as data storage devices 730 for storing data within database 720, such as storing 502 (shown in FIG. 5) merchant data. Computing device 710 further includes a communications component 740 for receiving 502 (shown in FIG. 5) merchant data from a plurality of merchants, receiving 506 (shown in FIG. 5) a product request message from user computing device 114 (shown in FIG. 1), receiving 508 (shown in FIG. 5) a selection message from user computing device 114, transmitting 514 (shown in FIG. 5) an authorization request message to an authorizing party, such as issuer bank 230 (shown in FIG. 2), receiving 516 an authorization response message from the authorizing party, and transmitting the authorization response message to user computing device 114 and merchant computing device 116 (shown in FIG. 1). Computing device 710 also includes a parsing component 750 for performing a look up 508 (shown in FIG. 5) for a match product descriptor including a match description matching a requested product description. Computing device 710 further includes a generator component 760 for generating 512 (shown in FIG. 5) an authorization request message including a user identifier and a price corresponding to a selected product identifier.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure has been described in terms of various specific embodiments, those skilled in the art will recognize that the disclosure can be practiced with modification within the spirit and scope of the claims.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

As will be appreciated based on the foregoing specification, the above-described embodiments of the disclosure may be implemented using computer programming or engineering techniques including computer software, firmware, hardware or any combination or subset thereof, wherein the technical effect is a flexible and fast system for various aspects of fraud analysis for registration of merchants with acquirer banks. Any such resulting program, having computer-readable code means, may be embodied or provided within one or more computer-readable media, thereby making a computer program product, i.e., an article of manufacture, according to the discussed embodiments of the disclosure. The article of manufacture containing the computer code may be made and/or used by executing the code directly from one medium, by copying the code from one medium to another medium, or by transmitting the code over a network.

In addition, although various elements of the data aggregator (DA) computing device are described herein as including general processing and memory devices, it should be understood that the DA computing device is a specialized computer configured to perform the steps described herein for aggregating, exchanging, and filtering data over a communications network.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial locational differences from the literal language of the claims.

What is claimed is:

1. A data aggregator (DA) system for aggregating data from multiple data sources over a communications network, the DA system comprising at least one data aggregator (DA) computing device communicatively coupled to a central database, the DA computing device configured to:
receive merchant data from a plurality of merchant computing devices, wherein the merchant data includes a merchant identifier for each merchant associated with at least one of the plurality of merchant computing devices and product data for each product offered for sale by each merchant, wherein the product data includes a product identifier and a product descriptor, and wherein the product descriptor includes a description of each product offered for sale;
store the merchant data within the central database by mapping the merchant data using the merchant identifier;
receive a product request message from a user computing device, wherein the product request message includes at least one requested product identifier and at least one requested product descriptor associated with each requested product identifier, and wherein each requested product descriptor includes a requested product description;
perform a look up within the central database for a match product descriptor including a match description matching the requested product description, wherein the match product descriptor is associated with a match product identifier;
receive a selection message from the user computing device, the selection message including a selected product identifier and a user identifier corresponding to a user of the user computing device, wherein the selected product identifier is associated with a selected merchant identifier corresponding to a merchant associated with one or more of the plurality of merchant computing devices;
generate an authorization request message including the user identifier and a price corresponding to the selected product identifier;
transmit the authorization request message to an authorizing party;
receive an authorization response message from the authorizing party; and
transmit the authorization response message to the user computing device and the merchant.

2. The DA system of claim 1 further configured to decrease a product inventory quantity corresponding to the selected product identifier.

3. The DA system of claim 1 further configured to identify, within the central database, at least one merchant associated with the requested product identifier.

4. The DA system of claim 1 further configured to:
generate a list including a list including one or more merchants each associated with the requested product identifier, wherein the list includes one or more merchants having at least one product offered for sale associated with the requested product description; and
transmit the list to the user computing device.

5. The DA system of claim 4 further configured to:
receive merchant selection data from the user computing device including at least one selected merchant from the list, wherein the at least one selected merchant is associated with the selected product identifier; and
receive payment data from the user computing device, wherein the payment data includes the authorization request message.

6. The DA system of claim 5 further configured to:
transmit the payment data to a payment processor; and
receive an authorization response message from the payment processor in response of authorizing, by the payment processor.

7. The DA system of claim 6 further configured to transmit the merchant selection data and the authorization response message to at least one merchant computing device associated the at least one selected merchant.

8. The DA system of claim 1, wherein the authorization request message is at least one of an ISO® 8583 compliant message and an ISO® 20022 compliant message.

9. The DA system of claim 1, wherein matching the match description to the requested product description comprises determining the match description is at least one of substantially similar and the same to the requested product description.

10. A computer-implemented method for aggregating data from multiple data sources over a communications network, said method implemented using a data aggregator (DA) comprising at least one data aggregator (DA) computing device communicatively coupled to a central database, said method comprising:
receiving merchant data from a plurality of merchant computing devices, wherein the merchant data includes a merchant identifier for each merchant associated with at least one of the plurality of merchant computing devices and product data for each product offered for sale by each merchant, wherein the product data includes a product identifier and a product descriptor, and wherein the product descriptor includes a description of each product offered for sale;
storing the merchant data within the central database by mapping the merchant data using the merchant identifier;
receiving a product request message from a user computing device, wherein the product request message includes at least one requested product identifier and at least one requested product descriptor associated with each requested product identifier, and wherein each requested product descriptor includes a requested product description;
performing a look up within the central database for a match product descriptor including a match description matching the requested product description, wherein the match product descriptor is associated with a match product identifier;
receiving a selection message from the user computing device, the selection message including a selected product identifier and a user identifier corresponding to a user of the user computing device, wherein the selected product identifier is associated with a selected merchant identifier corresponding to a merchant associated with one or more of the plurality of merchant computing devices;
generating an authorization request message including the user identifier and a price corresponding to the selected product identifier;
transmitting the authorization request message to an authorizing party;
receiving an authorization response message from the authorizing party; and
transmitting the authorization response message to the user computing device and the merchant.

11. The method of claim 10 further comprising decreasing a product inventory quantity corresponding to the selected product identifier.

12. The method of claim 10 further comprising identifying, within the central database, at least one merchant associated with the requested product identifier.

13. The method of claim 10 further comprising:
generating a list including a list including one or more merchants each associated with the requested product identifier, wherein the list includes one or more merchants having at least one product offered for sale associated with the requested product description; and
transmitting the list to the user computing device.

14. The method of claim 13 further comprising:
receiving merchant selection data from the user computing device including at least one selected merchant from the list, wherein the at least one selected merchant is associated with the selected product identifier; and
receiving payment data from the user computing device, wherein the payment data includes the authorization request message.

15. The method of claim 14 further comprising:
transmitting the payment data to a payment processor; and
receiving an authorization response message from the payment processor in response of authorizing, by the payment processor.

16. The method of claim 15 further comprising transmitting the merchant selection data and the authorization response message to at least one merchant computing device associated the at least one selected merchant.

17. The method of claim 10, wherein the authorization request message is at least one of an ISO® 8583 compliant message and an ISO® 20022 compliant message.

18. The method of claim 10, wherein matching the match description to the requested product description comprises determining the match description is at least one of substantially similar and the same to the requested product description.

19. A non-transitory computer-readable storage media having computer-executable instructions embodied thereon, wherein when executed by a data aggregator (DA) computing device having at least one processor coupled to at least one memory device, the computer-executable instructions cause the processor to:
receive merchant data from a plurality of merchant computing devices, wherein the merchant data includes a merchant identifier for each merchant associated with at least one of the plurality of merchant computing devices and product data for each product offered for sale by each merchant, wherein the product data includes a product identifier and a product descriptor, and wherein the product descriptor includes a description of each product offered for sale;
store the merchant data within the central database by mapping the merchant data using the merchant identifier;
receive a product request message from a user computing device, wherein the product request message includes at least one requested product identifier and at least one requested product descriptor associated with each requested product identifier, and wherein each requested product descriptor includes a requested product description;
perform a look up within the central database for a match product descriptor including a match description matching the requested product description, wherein the match product descriptor is associated with a match product identifier;
receive a selection message from the user computing device, the selection message including a selected product identifier and a user identifier corresponding to a user of the user computing device, wherein the selected product identifier is associated with a selected merchant identifier corresponding to a merchant associated with one or more of the plurality of merchant computing devices;
generate an authorization request message including the user identifier and a price corresponding to the selected product identifier;
transmit the authorization request message to an authorizing party;
receive an authorization response message from the authorizing party; and
transmit the authorization response message to the user computing device and the merchant.

20. The computer-executable instructions of claim 19 further cause the processor to decrease a product inventory quantity corresponding to the selected product identifier.
